(19) United States
(12) Patent Application Publication
(10) Pub. No.: US 2015/0128043 A1
(43) Pub. Date: May 7, 2015

(54) APPARATUS, METHOD AND SYSTEM FOR MANAGING AVN

(71) Applicant: HYUNDAI MOTOR COMPANY, Seoul (KR)

(72) Inventor: Hyun Chul Sim, Suwon (KR)

(73) Assignee: HYUNDAI MOTOR COMPANY, Seoul (KR)

(21) Appl. No.: 14/287,764

(22) Filed: May 27, 2014

(30) Foreign Application Priority Data
Nov. 1, 2013 (KR) 10-2013-0132474

(51) Int. Cl. G06F 3/0481

(52) U.S. Cl. CPC G06F 3/0481
USPC 715/719

(57) ABSTRACT

An apparatus, a method, and a system for managing an audio video navigation (AVN) are provided. The method includes collecting, by a processor, status information related to a vehicle and a surrounding environment of the vehicle and providing the collected information to a download server to store a plurality of UI configuration files for an application of an AVN system and download a UI configuration file that correspond to the collected information. In addition, the downloaded UI configuration file is stored by the processor in a specified memory area which is accessed in various mode conversions and implemented an execution application screen of the AVN system.

### CROSS-REFERENCE TO RELATED APPLICATION

This application claims the benefit of priority to Korean Patent Application No. 10-2013-0132474, filed on Nov. 1, 2013 in the Korean Intellectual Property Office, the disclosure of which is incorporated herein in its entirety by reference.

### BACKGROUND

1. Field of the Invention

The present invention relates to an apparatus, a method, and a system for managing an audio video navigation (AVN), and more particularly, to a technology of updating a user interface (UI) for an execution application of an AVN system.

2. Description of the Related Art

A user interface (UI) for an execution application of an audio video navigation (AVN) system of a vehicle is distributed and managed in a form of an executable binary file. In particular, to apply a new UI to the application of the AVN system, a source code of an existing application is modified to generate a new binary, and the booting memory (NAND) of the AVN system is formatted and a new software package is upgraded.

However, in the conventional AVN system, only a user who has expertise can apply the new UI. In addition, when a user who does not have expertise, to apply the new UI in the AVN system, the user is required to visit a specialized company and upgrade the software package of the AVN system.

### SUMMARY

The present invention provides an apparatus, a method, and a system that update a UI of an AVN system by downloading a configuration file for an execution application of the AVN system.

In accordance with an aspect of the present invention, an apparatus for managing an audio video navigation (AVN) may include: an information collector configured to collect status information related to a vehicle and a surrounding environment of the vehicle; an application (app) manager configured to provide the collected information to a download server configured to store a plurality of UI configuration files for an application of an AVN system and download a UI configuration file that corresponds to the collected information; an app storage configured to store the downloaded UI configuration file in a specified memory area; and a browser configured to pull the UI configuration file stored in the specified memory area in various mode conversions and implement an execution application screen of the AVN system.

The app manager may be configured to download a plurality of UI configuration files generated by the download server in response to the collected information. The app manager may be configured to store one file selected from among the plurality of UI configuration files into the specified area. The browser may be configured to provide a list of the plurality of UI configuration files and implement an execution application screen of the AVN system based on the UI configuration file selected from the list, when the plurality of the UI configuration files are stored in the specified area. The application of the AVN system may be made by a hypertext markup language 5 (HTML5). The UI configuration file may be a cascading style sheets (CSS) file.

In accordance with another aspect of the present invention, an apparatus for managing an audio video navigation (AVN) may include: an information collector configured to collect status information related to a vehicle and a surrounding environment of the vehicle; an app manager configured to provide the collected information to a portable terminal which may be communication-connected to a download server configured to store a plurality of UI configuration files for an application of an AVN system, and download a UI configuration file that corresponds to the information collected via the portable terminal; an app storage configured to store the downloaded UI configuration file in a specified memory area; and a browser configured to pull the UI configuration file stored in the specified memory area in various mode conversions and implement an execution application screen of the AVN system.

In accordance with another aspect of the present invention, a method of managing an audio video navigation (AVN) may include: collecting status information related to a vehicle and a surrounding environment of the vehicle; providing the collected information to a download server configured to store a plurality of UI configuration files for an application of an AVN system; downloading a UI configuration file that corresponds to the collected information from the download server; storing the downloaded UI configuration file in a specified memory area; and pulling (e.g., accessing) the UI configuration file stored in the specified memory area in various mode conversions and implementing an execution application screen of the AVN system.

In accordance with another aspect of the present invention, a method of managing an audio video navigation (AVN) may include: collecting status information related to a vehicle and a surrounding environment of the vehicle; providing the collected information to a portable terminal which may be communication-connected to a download server configured to store a plurality of UI configuration files for an application of an AVN system; downloading a UI configuration file that corresponds to the collected information provided from the download server via the portable terminal; storing the downloaded UI configuration file in a specified memory area; and pulling the UI configuration file stored in the specified memory area in various mode conversions and implementing an execution application screen of the AVN system.

In accordance with another aspect of the present invention, an audio video navigation (AVN) management system may include: a download server configured to store a plurality of UI configuration files for an application of an AVN system; an AVN management apparatus configured to download a UI configuration file that corresponds to a surrounding environment of a vehicle and a vehicle status by accessing the download server, and store the downloaded UI configuration file in a memory area accessed by a browser implementing an execution application of the AVN system. The download server may be configured to store at least one of a CSS file by season, a CSS file by weather, a CSS file by vehicle status, and a CSS file by driver's status. The download server may be configured to receive information that corresponds to the surrounding environment of the vehicle and the vehicle status from the AVN management apparatus, and provide at least one CSS file to the AVN management apparatus by combining the CSS file stored based on information provided from the AVN management apparatus.

In accordance with another aspect of the present invention, an audio video navigation (AVN) management system may include: a download server configured to store a plurality of UI configuration files for an application of an AVN system; a portable terminal configured to be communication-connected to the download server and download a UI configuration file that corresponds to a surrounding environment of a vehicle and a vehicle status; and an AVN management apparatus configured to provide information related to the surrounding environment of the vehicle and the vehicle status by accessing the portable terminal, download a UI configuration file from the portable terminal, and store the downloaded UI configuration file in a memory area accessed by a browser implementing an execution application of the AVN system.

### BRIEF DESCRIPTION OF THE DRAWINGS

The objects, features and advantages of the present invention will be more apparent from the following detailed description in conjunction with the accompanying drawings, in which:

FIG. 1 is an exemplary diagram illustrating a configuration of an AVN management system according to an exemplary embodiment of the present invention;

FIG. 2 is an exemplary diagram illustrating a configuration of an AVN management system according to another exemplary embodiment of the present invention;

FIG. 3 is an exemplary block diagram illustrating a configuration of an AVN management apparatus according to an exemplary embodiment of the present invention;

FIG. 4 is an exemplary diagram illustrating a memory structure of an AVN management apparatus according to an exemplary embodiment of the present invention;

FIG. 5 is an exemplary block diagram illustrating a configuration of a download server according to an exemplary embodiment of the present invention;

FIG. 6 is an exemplary diagram illustrating a memory structure of a download server according to an exemplary embodiment of the present invention;

FIG. 7 is an exemplary embodiment of diagram illustrating an operation of an AVN management apparatus according to an exemplary embodiment of the present invention;

FIG. 8 is an exemplary flowchart illustrating a flow of operation of an AVN management method according to an exemplary embodiment of the present invention; and

FIG. 9 is an exemplary flowchart illustrating a flow of operation of an AVN management method according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

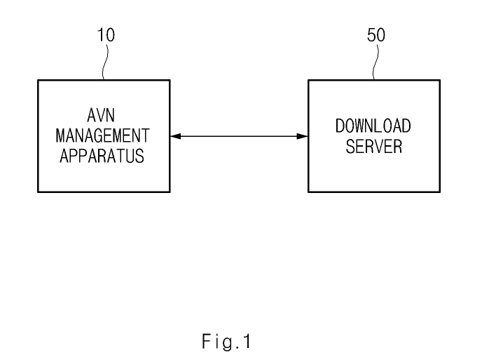

FIG. 1 is an exemplary diagram illustrating a configuration of an AVN management system according to an exemplary embodiment of the present invention. Referring to FIG. 1, the AVN management system of the present invention may include an AVN management apparatus 10 and a download server 50.

The download server 50 may be configured to store a plurality of UI configuration files for an application of an audio video navigation (AVN) system, and provide the stored UI configuration file according to the request of the AVN management apparatus 10. In particular, it may be assumed that the UI configuration file is a cascading style sheets (CSS) file. The CSS file may be a style sheet in which an overall style of a web document is previously stored. Therefore, a font size, a font, a line spacing, a background color, and an arrangement position displayed on an application screen of the AVN system may be previously defined and stored in the CSS file.

In addition, it may be assumed that the application of the AVN system is written by hypertext markup language 5 (HTML5). Particularly, the application written by HTML5 may be configured with a HTML file that defines a structure of the application, a Javascript file that defines a user response which is an operation of the application, and a CSS file that defines a screen configuration of the application. Thus, the UI may be changed by changing the CSS file that defines a screen configuration of application.

Meanwhile, the download server 50 may be configured to store at least one of a CSS file by season, a CSS file by weather, a CSS file by vehicle status, and a CSS file by driver's status. Further, the download server 50 may be configured to generate at least one CSS file by combining the CSS file stored based on information received from the AVN management apparatus 10 (e.g., a processor of the AVN management apparatus), when information related to the vehicle's surrounding environment and the vehicle status is received from the AVN management apparatus 10. Thus, the download server 50 may be configured to provide at least one CSS file, generated in response to information received from the AVN management apparatus 10, to the AVN management apparatus 10.

The AVN management apparatus 10 may be configured to support a communication interface such as a modem, and may be configured to access the download server 50 via the communication interface. When the AVN management apparatus 10 requests a change to the UI for the application of the AVN system, the AVN management apparatus 10 (e.g., the processor of the apparatus) may be configured to access the download server 50 to download a new CSS file. Further, the AVN management apparatus 10 may be configured to store the downloaded CSS file in a memory area which may be accessed by a browser that implements the execution application of the AVN system.

In particular, to download the CSS file, the AVN management apparatus 10 may be configured to collect vehicle status information, surrounding environment information, driver's status information, and the like to provide to the communication-connected download server 50. Additionally, AVN management apparatus 10 may be configured to download at least one CSS file generated based on the information provided to the download server 50 to apply to the AVN system. When a plurality CSS files are downloaded from the download server 50, a single CSS file may be selected to be applied to the AVN system.

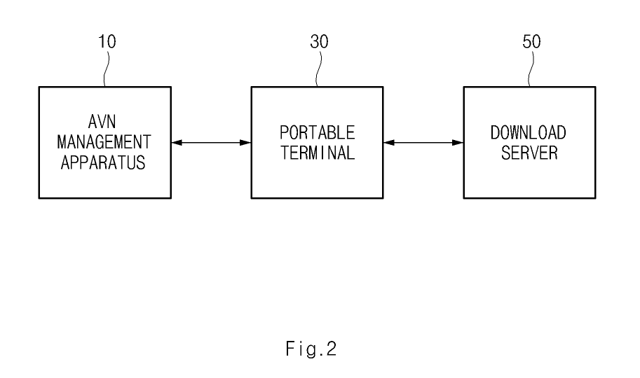

FIG. 2 is an exemplary diagram illustrating a configuration of an AVN management system according to another exemplary embodiment of the present invention. FIG. 2 illustrates another exemplary embodiment of FIG. 1, illustrating that the CSS file may be downloaded via a portable terminal 30 when the AVN management apparatus does not support a communication interface for communication with the download server 50. In other words, the AVN management system may include an AVN management apparatus 10 (e.g., operated by a processor), a portable terminal 30 and a download server 50. In particular, the basic operation of the AVN management apparatus 10 and the download server 50 is substantially similar with FIG. 1. Thus, the description of overlapped operation of elements overlapped with FIG. 1 will be omitted.

The AVN management apparatus 10 applied to the AVN management system of FIG. 2 may not support a communication interface for communications with the download server 50. Even when supporting the communication interface for communication with the download server 50, the CSS file may be downloaded via the portable terminal 30 according to user's selection.

The AVN management apparatus 10 may access the portable terminal 30 to download the CSS file. Further, the AVN management apparatus 10 may be configured to access the portable terminal 30 via a universal serial bus (USB) communication, and, in addition, access the portable terminal 30 using a short-range communication method. Thus, when accessing the portable terminal 30, the AVN management apparatus 10 may be configured to collect the vehicle status information, the surrounding environment information, the driver's status information, and the like, and transmit the collected information to the portable terminal 30 while requesting the download of the CSS file simultaneously.

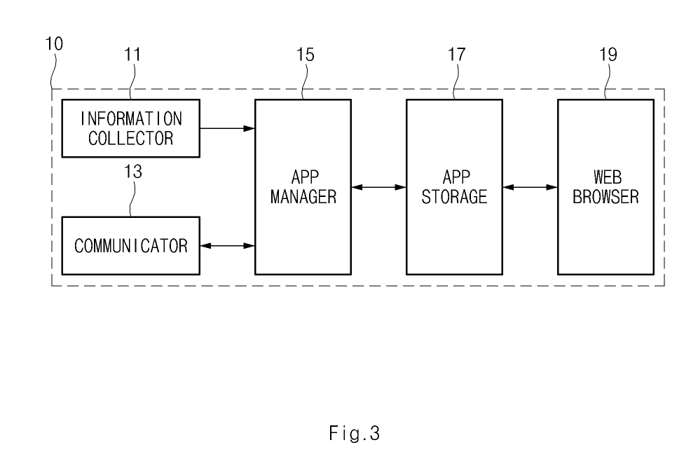

Meanwhile, it may be assumed that the portable terminal 30 is a terminal that supports a communication interface which may communication-access to the AVN management apparatus 10, and communicate with the download server 50. As an example, the portable terminal 30 may be a smart phone, a tablet personal computer (PC), and the like. The portable terminal 30 may be configured to access the download server 50 via the internet based on to the request of the AVN management apparatus 10, and transmit the information provided from the AVN management apparatus 10 to the download server 50 to request the CSS file. Additionally, the portable terminal 30 may be configured to download at least one CSS file generated based on the vehicle status information, surrounding environment information, and driver's status information from the download server 50 to temporarily store. The AVN management apparatus 10 may be configured to download at least one CSS file temporarily stored in the portable terminal 30. In particular, as illustrated in FIG. 1, the AVN management apparatus 10 may be configured to store the downloaded CSS file in a specified memory area. Thus, the detailed configuration of the AVN management apparatus 10 applied to the invention is described in more detail with reference to FIG. 3.

FIG. 3 is an exemplary block diagram illustrating a configuration of an AVN management apparatus according to an exemplary the present invention. As shown in FIG. 3, the AVN management apparatus 10 of the present invention may include an information collector 11, a communicator 13, an app manager 15, an app storage 17, and a browser 19.

The information collector 11 may include a sensor configured to collect status information, for example, a traveling speed, based on the operation of each driving means of vehicle. Further, the information collector 11 may be configured to collect vehicle surrounding environment information, e.g., a weather, a temperature, a surrounding traffic condition, a road condition, etc., from the exterior of the vehicle. Further, the information collector 11 may be configured to collect the driver's psychology, the state of distraction, and the state of drowsiness.

The communicator 13 may include a communication module configured to support the communication interface to transmit and receive a signal with the download server 50. Meanwhile, the communicator 13 may also include a communication module configured to support the communication interface for the USB communication or the short-distance wireless communication with the portable terminal 30.

The app manager 15 may be executed by the processor and configured to manage a file for the execution of the application of the AVN system. In particular, the application applied to the present invention may be an application written by HTML5, and may be configured with a HTML file that defines a structure of the application, a Javascript file that defines a user response which is an operation of the application, and a CSS file that defines a screen configuration of the application. Thus, the app manager 15 may be configured to operate the UI of the application screen by managing the CSS file during when the application of the AVN system is performed. In other words, the app manager 15 may be configured to request the collection of information to the information collector 11 to request a new CSS file to the download server 50. Further, the app manager 15 may be configured to access the download server 50 via the communicator 13 to download the CSS file. Further, the app manager 15 may be configured to transmit the information collected by the information collector 11 to the download server 50.

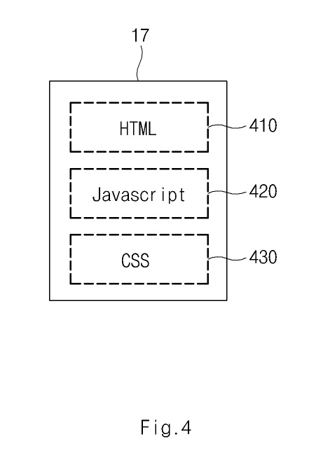

When at least one CSS file is generated in the download server 50 based on the information transmitted to the download server 50 by the app manager 15, the app manager 15 may be configured to download at least one CSS file generated by the download server 50 to store into the app storage 17. In particular, the app storage 17 may be configured to predefine a memory area in which the CSS file is stored, and store a corresponding CSS file in a pre-defined memory area when the CSS file is downloaded from the download server 50 by the app manager 15. Additionally, the app storage 17 may be configured to store files for implementing the application beyond the CSS file. The detailed description of the app storage 17 is described with reference to FIG. 4.

FIG. 4 is an exemplary diagram illustrating a memory structure of an AVN management apparatus according to an exemplary embodiment of the present invention. Referring to FIG. 4, the app storage 17 may be configured to allocate a memory area for the implementation of the application, and subdivide the assigned memory area into a HTML area, a Javascript area, and a CSS area.

Further, the HTML area may store the HTML file that defines the structure of the application. In addition, the Javascript area may store the Javascript file that defines a user response which is an operation of the application. The CSS area may store the CSS file that defines a screen configuration of the application. In particular, the HTML file, the Javascript file, and the CSS file may each be a text file of UTF-8 format. The CSS file may be a memory area accessed (e.g., pulled) by the browser 19 when the mode of the browser 19 is converted during the execution of the application. The browser 19 may be configured to implement the screen of the execution application by accessing the CSS file stored in the CSS area of the app storage 17 when the application of the AVN system is executed. In particular, the browser 19 may be configured to access the CSS file stored in the CSS area in various mode conversions.

When the app manager 15 downloads the new CSS file from the download server 50 to store into the CSS area allocated for a corresponding application in the storage 17, without newly executing the browser 19, the UI of the application screen may be updated based on the UI configuration information stored in the new CSS file, by accessing the new CSS file stored in the CSS area at the time of mode conversion.

Moreover, the app manager 15 may be configured to request an access to the portable terminal 30, when a communication access to the download server 50 via the communicator 13 fails, or when the communication module which may be configured to communicate with the download server 50 is non-activated based on the request of the user. In particular, the app manager 15 may be configured to request a download of the CSS file by transmitting the information collected by the information collector 11 to the portable terminal 30. Then, when the CSS file downloaded from the download server 50 is temporarily stored in a specified area of the portable terminal 30, the app manager 15 may be configured to download the CSS file from the portable terminal 30 to store into the CSS area allocated for the application in the app storage 17.

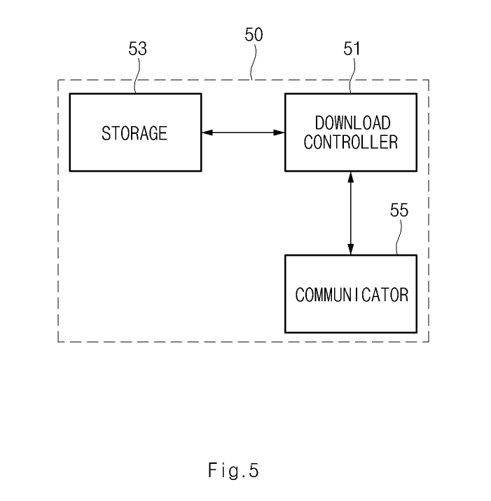

FIG. 5 is an exemplary block diagram illustrating a configuration of a download server according to an exemplary embodiment of the present invention. Referring to FIG. 5, the download server 50 may include a download controller 51, a storage 53 and a communicator 55. In particular, the download controller 51 may be configured to generate the CSS file based on the request of the AVN management apparatus 10 or the portable terminal 30, and provide the generated CSS file to the AVN management apparatus 10 or the portable terminal 30.

Further, the download controller 51 may be configured to generate the CSS file based on at least one of the vehicle status information, the surrounding environment information, and the driver's status information provided from the AVN management apparatus 10 or the portable terminal 30. The download server 50 may be configured to extract and provide the CSS file that corresponds to the information provided from the AVN management apparatus 10 or the portable terminal 30 among the CSS files stored in the storage 53.

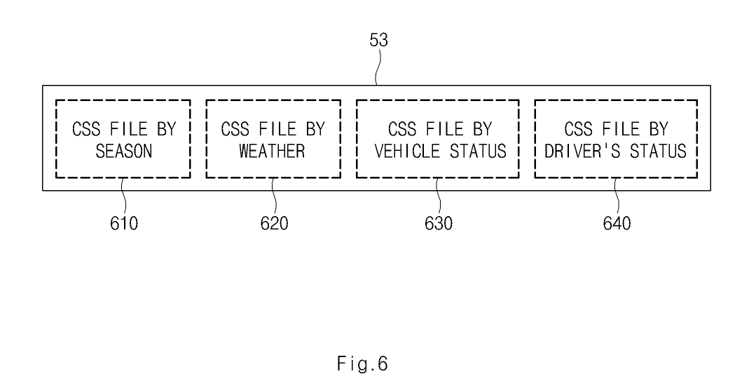

The storage 53 may be executed by a processor of the download controller 51 to store a plurality of CSS files for the application of the AVN system. In particular, the storage 53 may be configured to store respective CSS files based on surrounding environment, vehicle status, and driver's status. As an example, as shown in FIG. 6, the storage 53 may be configured to store the CSS file by season, the CSS file by weather, the CSS file by vehicle status, and the CSS file by driver's status respectively. The storage 53 (e.g., the processor) may be configured to generate at least one new CSS file by combining the CSS file stored in the storage 53 based on information provided from the AVN management apparatus 10 or the portable terminal 30, or extract the CSS file suitable for each status respectively to provide to the AVN management apparatus 10 or the portable terminal 30.

The communicator 55 may be executed by the processor of the download controller 51 to support the communication interface which may be connected to the AVN management apparatus 10 or the portable terminal 30 via an internet network. The communicator 55 may be communication-connected with the AVN management apparatus 10 or the portable terminal 30, and may be connected simultaneously. Further, when at least one CSS file is generated by the download controller 51, or the CSS file stored in the storage 53 is extracted, the communicator 55 may be configured to transmit a corresponding CSS file based on the request of the AVN management apparatus 10 or the portable terminal 30.

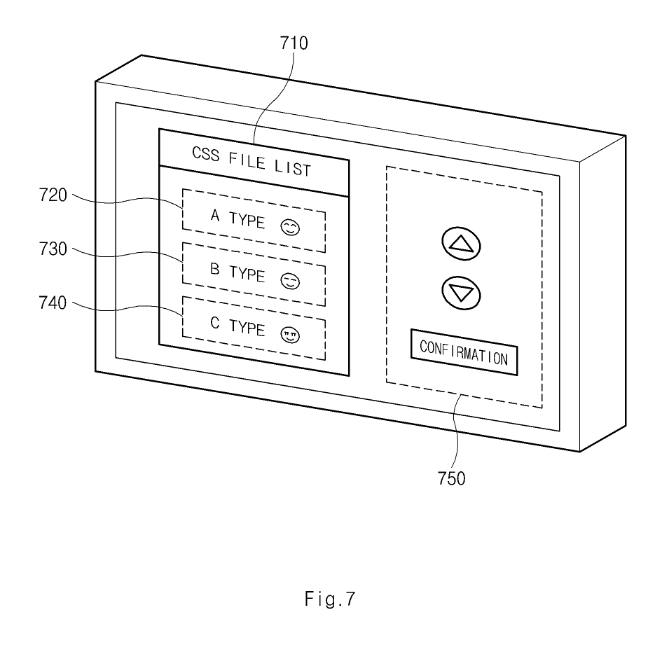

FIG. 7 is an exemplary diagram illustrating an operation of an AVN management apparatus according to an exemplary embodiment of the present invention. Referring to FIG. 7, the AVN management apparatus may download a plurality of CSS files from the download server or the portable terminal 30. Since the browser of the AVN management apparatus may be configured to implement the application screen of the AVN system based on one CSS file, the browser may be configured to select one CSS file to be applied to the execution application when a plurality of CSS files are downloaded.

In particular, the AVN management apparatus may configure a CSS file list for the plurality of CSS files to provide to a user, and may implement the application screen based on a user selected item. As an example, when three CSS files, that is, ‘A TYPE’, ‘B TYPE’, and ‘C TYPE’ are downloaded from the download server or the portable terminal, the AVN management apparatus may configure a CSS file list 710 that includes an ‘A TYPE’ item 720, a ‘B TYPE’ item 730, and a ‘C TYPE’ item 740 to provide to the user, and may implement the application screen based on an item selected by the user. The user may select one item by touching the CSS file list 710, and may select one item by operating a button operating unit 750 disposed on a screen.

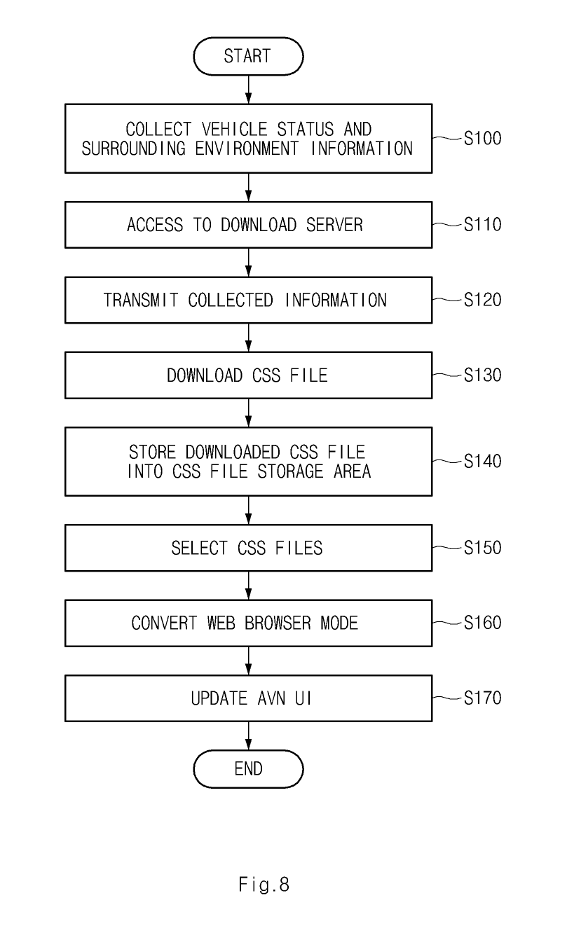

The operation flow of the above mentioned AVN management apparatus according to an exemplary embodiment the present invention is described in more detail as follows. FIG. 8 is an exemplary flowchart illustrating a flow of operation of an AVN management method according to an exemplary embodiment of the present invention. As shown in FIG. 8, the AVN management apparatus may be configured to collect information related to the vehicle status and the surrounding environment (S100). That is, the processor of the apparatus may be configured to collect the information. In addition, the AVN management apparatus may be configured to access to the download server (S110), and transmit the information collected at step ‘S100’ to the download server (S120).

Thereafter, when at least one CSS file is generated in the download server based on the information transmitted at step ‘S120’, the AVN management apparatus may be configured to download a corresponding CSS file from the download server (S130). In addition, the AVN management apparatus may be configured to store the CSS file downloaded at step ‘S130’ into a specified CSS file storage area (S140).

When a plurality of CSS files are stored in the specified CSS file storage area at step ‘S140’, the AVN management apparatus may be configured to select any one of the CSS files based on a user's operation (S150). Additionally, the AVN management apparatus may be configured to provide a CSS file list for a plurality of CSS files to the user, to allow the user to select one CSS file. Alternately, only the CSS file selected by the user may be stored in the CSS file storage area. When the AVN management apparatus converts the mode of the browser that implements the execution application screen of the AVN system, after storing the CSS file downloaded at step ‘S140’ into the CSS file storage area (S160), the UI of the AVN system may be updated by accessing the CSS file stored in the specified CSS file storage area by the browser (S170).

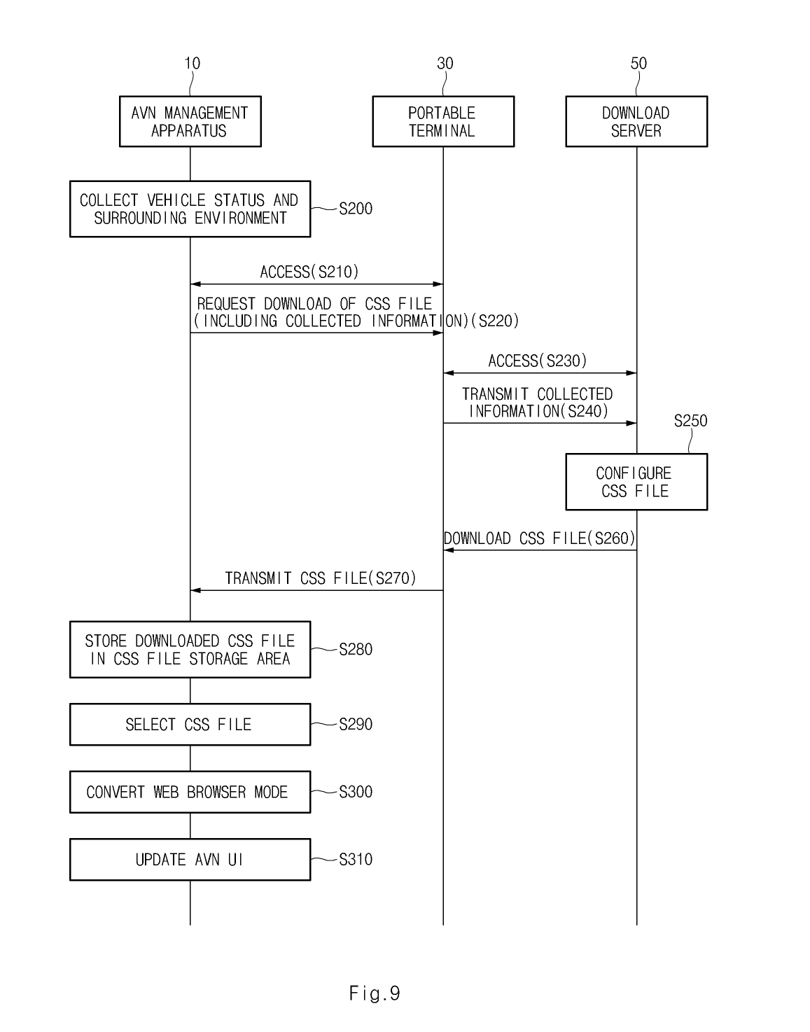

FIG. 9 is an exemplary flowchart illustrating a flow of operation of an AVN management method according to another exemplary embodiment of the present invention, illustrating a process of downloading the CSS file via the portable terminal by the AVN management apparatus. Referring to FIG. 9, the AVN management apparatus 10 may be configured to collect information related to the vehicle status and the surrounding environment (S200). In addition, the AVN management apparatus 10 may be configured to access to the portable terminal 30 (S210), and request the download of the CSS file by transmitting the information collected at step ‘S200’ to the portable terminal 30 (S220).

Moreover, the portable terminal 30 may be configured to access to the download server 50 based on the request of the AVN management apparatus 10 (S230), and transmit the collected information of the AVN management apparatus 10 received at step ‘S220’ to the download server 50 (S240). Thereafter, the download server 50 may configure at least one CSS file based on the information received at step ‘S240’ (S250). Accordingly, the portable terminal 30 may be configured to download a corresponding CSS file from the download server 50 (S260), and transmit the CSS file downloaded from the download server 50 to the AVN management apparatus 10 based on the request of the AVN management apparatus 10 (S270).

Further, the AVN management apparatus 10 may be configured to store the CSS file received at step ‘S270’ into the specified CSS file storage area (S280). When a plurality of CSS files are stored in the specified CSS file storage area at step ‘S280’, the AVN management apparatus 10 may be configured to select any one CSS file based on user's operation (S290). The AVN management apparatus 10 may be configured to provide the CSS file list for a plurality of CSS files to the user, to allow the user to select a CSS file. In addition, the AVN management apparatus 10 may be configured to store only the CSS file selected by the user into the CSS file storage area. After storing the CSS file downloaded at step ‘S280’ into the CSS file storage area, when the AVN management apparatus converts the mode of the browser that implements the execution application screen of the AVN system (S300), the UI of the AVN system may be updated by accessing the CSS file stored in the specified CSS file storage area by the browser (S310).

According to the invention, the UI of the AVN system may be updated by downloading a configuration file for the execution application of the AVN system, to change the UI of the AVN system without manually upgrading the software of the AVN system using the user's expertise, or visiting a specialized company.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the accompanying claims.

What is claimed is:

1. An apparatus for managing an audio video navigation (AVN), the apparatus comprising:
a memory configured to store program instructions; and
a processor configured to execute the program instructions, the program instructions when executed configured to:
collect status information related to a vehicle and a surrounding environment of the vehicle;
provide the collected information to a download server to store a plurality of user interface (UI) configuration files for an application of an AVN system and download a UI configuration file that corresponds to the collected information;
store the downloaded UI configuration file in a specified memory area; and
access the UI configuration file stored in the specified memory area in various mode conversions and implement an execution application screen of the AVN system.

2. The apparatus of claim 1, wherein a plurality of UI configuration files generated by the download server are downloaded in response to the collected information.

3. The apparatus of claim 2, wherein one file selected from the plurality of UI configuration files is stored into the specified area.

4. The apparatus of claim 2, wherein the program instructions when executed are further configured to:
provide a list of the plurality of UI configuration files and implement an execution application screen of the AVN system based on the UI configuration file selected from the list, when the plurality of the UI configuration files are stored in the specified area.

5. The apparatus of claim 1, wherein the application of the AVN system is made by a hypertext markup language 5 (HTML5).

6. The apparatus of claim 1, wherein the UI configuration file is a cascading style sheets (CSS) file.

7. An apparatus for managing an audio video navigation (AVN), the apparatus comprising:
a memory configured to store program instructions; and
a processor configured to execute the program instructions, the program instructions when executed configured to:
collect status information related to a vehicle and a surrounding environment of the vehicle;
provide the collected information to a portable terminal which is communication-connected to a download server to store a plurality of user interface (UI) configuration files for an application of an AVN system, and download a UI configuration file that corresponds to the information collected via the portable terminal;
store the downloaded UI configuration file in a specified memory area; and
access the UI configuration file stored in the specified memory area in various mode conversions and implement an execution application screen of the AVN system.

8. A method for managing an audio video navigation (AVN), the method comprising:
collecting, by a processor, status information related to a vehicle and a surrounding environment of the vehicle;
providing, by the processor, the collected information to a download server to store a plurality of user interface (UI) configuration files for an application of an AVN system;
downloading, by the processor, a UI configuration file that corresponds to the collected information from the download server;
storing, by the processor, the downloaded UI configuration file in a specified memory area; and
accessing, by the processor, the UI configuration file stored in the specified memory area in various mode conversions and implementing an execution application screen of the AVN system.

9. A method for managing an audio video navigation (AVN), the method comprising:
collecting, by a processor, status information related to a vehicle and a surrounding environment of the vehicle;
providing, by the processor, the collected information to a portable terminal which is communication-connected to a download server to store a plurality of user interface (UI) configuration files for an application of an AVN system;
downloading, by the processor, a UI configuration file that corresponds to the collected information provided from the download server via the portable terminal;
storing, by the processor, the downloaded UI configuration file in a specified memory area; and
accessing, by the processor, the UI configuration file stored in the specified memory area in various mode conversions and implementing an execution application screen of the AVN system.

10. An audio video navigation (AVN) management system comprising:
a download server configured to store a plurality of user interface (UI) configuration files for an application of an AVN system; and
an AVN management apparatus having a memory configured to store program instructions and a processor configured to execute the program instructions, the program instructions when executed configured to:
download a user interface (UI) configuration file that corresponds to a surrounding environment of a vehicle and a vehicle status by accessing to the download server; and
store the downloaded UI configuration file in a memory area accessed by a browser implementing an execution application of the AVN system.

11. The AVN management system of claim 10, wherein the download server is configured to store at least one of a CSS file by season, a CSS file by weather, a CSS file by vehicle status, and a CSS file by driver's status.

12. The AVN management system of claim 10, wherein the download server is configured to receive information that corresponds to the surrounding environment of the vehicle and the vehicle status from the AVN management apparatus, and provide at least one CSS file to the AVN management apparatus by combining the CSS file stored based on information provided from the AVN management apparatus.

13. An audio video navigation (AVN) management system comprising:
a download server configured to store a plurality of user interface (UI) configuration files for an application of an AVN system;
a portable terminal configured to be communication-connected to the download server and download a UI configuration file that corresponds to a surrounding environment of a vehicle and a vehicle status; and
an AVN management apparatus having a memory configured to store program instructions and a processor configured to execute the program instructions, the program instructions when executed configured to:
provide information related to the surrounding environment of the vehicle and the vehicle status by accessing to the portable terminal;
download a UI configuration file from the portable terminal; and
store the downloaded UI configuration file in a memory area accessed by a browser implementing an execution application of the AVN system.

14. A non-transitory computer readable medium containing program instructions executed by a processor, the computer readable medium comprising:
program instructions that collect status information related to a vehicle and a surrounding environment of the vehicle;
program instructions that provide the collected information to a download server to store a plurality of user interface (UI) configuration files for an application of an AVN system;
program instructions that download a UI configuration file that corresponds to the collected information from the download server;
program instructions that store the downloaded UI configuration file in a specified memory area; and
program instructions that access the UI configuration file stored in the specified memory area in various mode conversions and implementing an execution application screen of the AVN system.

15. A non-transitory computer readable medium containing program instructions executed by a processor, the computer readable medium comprising:
program instructions that collect status information related to a vehicle and a surrounding environment of the vehicle;
program instructions that provide the collected information to a portable terminal which is communication-connected to a download server to store a plurality of user interface (UI) configuration files for an application of an AVN system;
program instructions that download a UI configuration file that corresponds to the collected information provided from the download server via the portable terminal;
program instructions that store the downloaded UI configuration file in a specified memory area; and
program instructions that access the UI configuration file stored in the specified memory area in various mode conversions and implementing an execution application screen of the AVN system.
